(19) United States
(12) Patent Application Publication
(10) Pub. No.: US 2004/0188878 A1
(43) Pub. Date: Sep. 30, 2004

(54) Cell bursting method of a plastic foam sheets

(76) Inventor: Ching Hsi Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/394,041

(22) Filed: Mar. 24, 2003

(51) Int. Cl. B29C 44/02

(52) U.S. Cl. 264/51; 264/101

(57) ABSTRACT

A cell bursting method of a plastic foam sheet includes steps of producing a foam sheet and carrying on vacuum cell bursting to the foam sheet. In the process of the vacuum cell bursting, air in the cells of the foam sheet inflates to expand their cell walls to a preset extent, and the instant when normal pressure recovers, the cell walls burst instantly due to rapid releasing of pressure, able to produce a plastic foam sheet having high flexibility, good permeability and excellent elasticity.

### BACKGROUND OF THE INVENTION

1. Field of the Invention

This invention relates to a cell bursting method of a plastic foam sheet, particularly to one including steps of producing a plastic foam sheet and carrying vacuum cell bursting to the plastic foam sheet to let the air inside the cells of the foam sheet inflated to burst their outer circumferential solid walls, able to produce a plastic foam sheet having high flexibility, good permeability, and excellent elasticity.

2. Description of the Prior Art

As commonly known, plastic foam sheets have physical properties of buffer, sound and heat insulation, floating and easy to be processed, so they are extensively employed for making shoe soles, shoe pads, and as a filling material, and a lining materials. In accordance with the structure of the air cells formed by blowing, plastic foam sheets are classified into closed-cell foam and opened-cell foam. The blown cells of the closed-cell foam are respectively an independent air chamber not communicating with one another, therefore a closed-cell foam sheet can be used as a floating apparatus on water, an elastomer or a bumper, but its defect is impermeable. The blown cells of the opened-cell foam communicating with one another, therefore the opened-cell plastic foam sheet has great permeability and water-absorbing property, but it is inferior to the closed-cell plastic foam sheet in buffer and elasticity.

For the present, an injecting molding machine is generally employed to produce opened-cell foam through continuous injecting molding, but the finished product is comparatively thin. Besides, in a producing process, blowing methods of radiation illuminating and filling in butane are applied, therefore cost for the needed equipment is high and it is liable to give rise to air explosion and a subsequent fire, and the physical property and the specifications of the products can hardly meet special demands in a sequent process.

An expedient method is to have closed-cell foam mechanically processed into opened-cell foam, as disclosed in a U.S. Pat. No. 6,103,163, titled “Processes and apparatuses for perforating smooth, closed-cell surfaces of open-cell plastic foam sheets” issued on Aug. 15, 2000. The method in this patent is to have various needles or pointed objects perforating the blowing cells of the closed-cell foam , but this mechanical method will surely spoil the resilient structure of the air chambers of the plastic foam sheet to lower support strength of the air chambers and also damage an intact appearance. Besides, the cells of the plastic foam sheet are perforated in a unanimously straight-line direction without perforating in a transverse direction. Further, the routes and the positions of the openings of the blown cells are of the same, so the cells are limited in their strength of sucking and releasing air and have poor resilience.

### SUMMARY OF THE INVENTION

One objective of the invention is to offer a cell bursting method of a plastic foam sheet, including producing a foam sheet and carrying out vacuum pumping and cell bursting to the foam sheet, letting the air inside the cells inflated to expand their outer circumferential cell walls to a preset extent. When normal pressure recovers, the air in the cells releases pressure instantly and burst the cell walls. Instead of the mechanical method of forceful breaking the air cells of a plastic foam, the method of vacuum bumping and normal pressure recovering can let the cells of the foam sheet inflated and rapidly releasing pressure repeatedly to burst the cell walls, maintaining the original support strength of the cell walls of the foam sheet, able to increase its resilience recovering strength after compressed, and having good flexibility and permeability.

Another objective of the invention is to offer a cell bursting method of a plastic foam sheet, in which a proper amount of fine hollow porcelain balls or other fine grains which do not combine with or react to plastic material is added to the plastic material during producing a plastic foam sheet. The foresaid hollow porcelain balls or the fine grains is dispersed evenly in the plastic material to be mixed together and then put in a mold for pressing and heating. When the mold is opened, the plastic foam sheet expands and blows instantly, but the hollow porcelain balls in the plastic material do not expand, but the cell walls expand and produce splitting through holes, thus obtaining a plastic foam sheet with a proper amount of opened cells. Then, a sequent step of vacuum cell bursting to this plastic foam sheet is carried out to increase an open rate of the cells.

### BRIEF DESCRIPTION OF DRAWINGS

This invention will be better understood by referring to the accompanying drawings, wherein:

FIG. 1 is a front view of a vacuum cell-bursting device in the present invention: and

FIG. 2 is a perspective view of the sealed portion of a plastic foam sheet in the present invention.

### DETAILED DESCRIPTION OF THE PREFERRED EMBODIMENT

A preferred embodiment of the method of producing an opened-cell plastic foam sheet in the present invention includes the following steps.

1. Producing a plastic foam sheet: A proper amount of plastic materials of ethylene vinyl acetate copolymer (EVA) and polyethylene resins (PE) or their mixture, a blowing agent, a vulcanizing agent, a stabilizer and an aids agent of a preset proportion are heated and mixed evenly to make up a plastic block. Then, the plastic block is pressed into a sheet material of a predetermined size suitable to be filled in a preset mold. After the sheet material is put in the mold, it is pressed and heated at a preset temperature (120°˜180° C.) for about 25˜40 minutes to let the blowing agent discomposed to blow and expand. Then, open the mold and take out the plastic foam sheet 10, which now has an expanded dimensions 6˜10 times as large as the original sheet material.

If the plastic foam sheet 10 needs a comparatively large blowing rate, it is put into the mold again to be pressed and heated at a preset temperature (165°˜180° C.) for about 15˜25 minutes to let the leftover blowing agent discomposed continuously to blow, letting the plastic foam sheet expanded 2˜3 times larger than the plastic foam sheet formed at the first time.

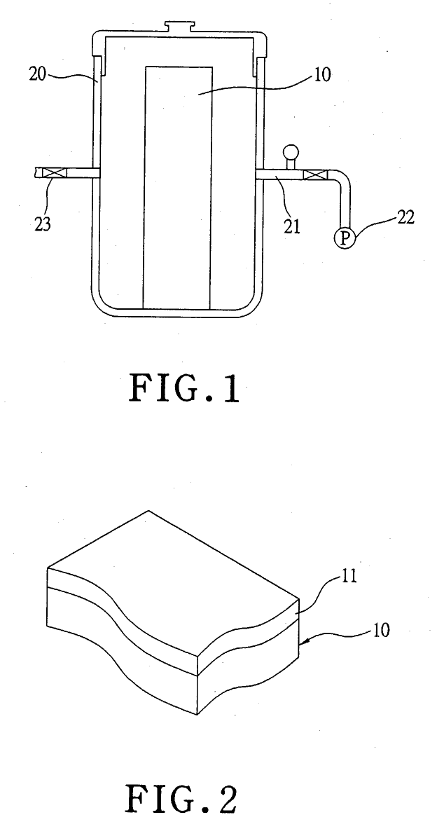

2. Carrying out vacuum cell bursting: The plastic foam sheet 10 is put in a closed vacuum chamber 20 connected with a vacuum pump 22 by a duct 21, as shown in FIG. 1. The vacuum pump 22 can pump out the air from the vacuum chamber 20 to become a vacuum negative-pressure state (from 760 mm. mercury to negative 400˜750 mm. mercury in this preferred embodiment).

The plastic foam sheet 10 is composed of numerous cells and solid cell walls between every two cells, with every cell having its interior full of air, therefore when the vacuum chamber 20 has its interior air pumped out and becomes a negative pressure condition, the air in the cells will be inflated to expand their outer circumferential walls to a preset extent. At this time, when a pressure-releasing valve 23 is opened, the pressure in the vacuum chamber 20 will instantly recover to 760 mm. mercury and the air in the cells will rapidly rush out of the fragile portions of the cell walls because the over-expanded cell wall releases pressure instantly, thus reaching a purpose of cell bursting of a plastic foam sheet.

In addition, the outer solid walls of the cells of the foam sheet 10 burst easily prior to the inner cells, because some inner cells during expanding are blocked by multi-layer abutting outer circumferential cell walls, therefore they cannot burst with the outer cells at the same time although they are under the same conditions of negative pressure and instant pressure releasing. Once the abutting outer circumferential cells burst and when the step of vacuum cell-bursting is repeated for a second time, the inner cell walls will burst, therefore the step of vacuum cell-bursting can be repeated for several times, depending on the dimensions and specifications of the product, and the demands of permeability and flexibility.

The foam sheet 10 of this invention has the interior air of its cells inflated to expand their solid walls to a predetermined extent and then burst open under the condition of rapid releasing of pressure when atmospheric pressure recovers instantly. The cells of the foam sheet 10 burst open at fragile portions of the cell walls, so the direction of cell bursting is not unanimous and the route of air releasing of each cell is not in a straight-line condition. Thus, the foam sheet made through vacuum cell-bursting has better elasticity and permeability than the conventional foam sheet which has its cell walls perforated mechanically in a straight-line condition to spoil its air chamber resilient structure. Besides, most of the solid walls of the cells burst through vacuum cell-bursting and form numerous foam cells respectively having openings of different directions, flexibility and permeability and also resilience property after compressed.

Furthermore, in the process of producing the foam sheet 10, if the solid walls of the cells respectively produce splitting fine through holes to form an opened-cell foam sheet having openings of different directions and then this foam sheet is processed with a step of vacuum cell-bursting, and cell bursting rate with one-round of cell bursting can be heightened.

Therefore, during the first step of producing the foam sheet, a proper amount of hollow porcelain balls or hollow fine grains impossible to combine with or react to plastic material is mixed together with the plastic material, letting the hollow porcelain balls or the hollow fine grains dispersed evenly in the plastic material. The hollow porcelain balls (preferably having a diameter around 12˜350 micron) are mainly composed of silicon oxide and aluminum oxide, while the hollow fine grains are hollow glass balls or the like. The hollow porcelain balls or the hollow fine grains are closed hollow balls respectively having a hollow interior and a very light weight, with irregular-shapes and different-quality materials.

As soon as the mold is opened to take out the foam sheet, the air accumulated in the plastic material will expand instantly to produce numerous air cells in the plastic material. At this time, the hollow porcelain balls dispersed evenly in the plastic material do not combine with nor react to the plastic material, therefore when the solid walls of the cells expand, the hollow porcelain balls do not expand at all, that is, the hollow porcelain balls and the plastic material are not compatible to each other, resulting in the cell walls expanding and producing splitting fine through holes. Thus, the permeation rate with one-round of cell bursting can be heightened during carrying out the second step of vacuum cell-bursting.

Additionally, a certain portion of the foam sheet 10 can be defined as a scaled portion 11, as shown in FIG. 2. Before carrying out a step of vacuum cell bursting, the sealed portion 11 is stuck with elastic adhesive tape, applied with elastic coating or with other effective method, thus the sealed portion 11 is formed with numerous closed cells. If a foam sheet with the sealed portion is used as a lining, a seat cushion or a camping mattress, the sealed portion of the foam sheet can be positioned at the bottom to prevent moisture on the ground from seeping therethrough.

While the preferred embodiment of the invention has been described above, it will be recognized and understood that various modifications may be made therein and the appended claims are intended to cover all such modifications that may fall within the spirit and scope of the invention.

I claim

1. A cell bursting method of a plastic foam sheet comprising:
(1). A first step of producing a foam sheet: a proper amount of plastic materials of ethylene vinyl acetate copolymer and polyethylene resins or their mixture mixed together with a blowing agent, a vulcanizing agent, a stabilizer and an aids agent of a preset proportion, said plastic material and all said agents mixed evenly and put in a mold for pressing and heating at a preset temperature and pressure, said mold opened to take out a foam sheet: and
(2) A second step of carrying out vacuum cell-bursting: said foam sheet put in a closed vacuum chamber, said vacuum chamber connected with a vacuum device, said vacuum device pumping out air from said vacuum chamber to form a vacuum negative-pressure condition, air in the cells of said foam sheet accordingly inflating and expanding their outer circumferential solid walls to a preset extent, said expanded cell walls bursting through their fragile portions due to instant releasing of pressure when normal pressure recovers.

2. The cell bursting method of a plastic foam sheet as claimed in claim 1, wherein during producing said foam sheet, a proper amount of hollow porcelain balls, hollow glass balls or fine grains impossible to combine with or react to plastic material is mixed with and dispersed evenly in said plastic material, and then the mixed material is put in a mold to be pressed and heated therein, The moment said mold is opened and said plastic material blows, Said porcelain or glass balls or fine grains do not expand the moment when said mold is opened, but said cell walls burst and produce splitting fine through holes, thus obtaining a proper amount of opened cells.

3. The cell bursting method of a plastic foam sheet as claimed in claim 1, wherein the second step of said vacuum cell-bursting is repeated for several times.

4. The cell bursting method of a plastic foam sheet as claimed in claim 1, wherein before carrying out said second step of vacuum cell bursting, said foam sheet may have a certain portion sealed by means of elastic adhesive tape, elastic coating or the like.
